(19) United States
(12) Patent Application Publication
(10) Pub. No.: US 2009/0037917 A1
(43) Pub. Date: Feb. 5, 2009

(54) Apparatus and method capable of using reconfigurable descriptor in system on chip

(75) Inventor: Kwang-Won Ko, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/979,682

(22) Filed: Nov. 7, 2007

(30) Foreign Application Priority Data
Jul. 31, 2007 (KR) 2007-0077127

(51) Int. Cl. G06F 9/50

(52) U.S. Cl. 718/102

(57) ABSTRACT

An apparatus and method capable of using a reconfigurable descriptor in a System on Chip (SoC) is provided. The apparatus includes: a Central Processing Unit (CPU) for receiving parameters, each of which defines a descriptor, from a user and for providing the parameters to a controller. The controller defines the descriptor by reading target data indicated by the received parameters.

### PRIORITY

This application claims the benefit under 35 U.S.C. § 119(a) of Korean patent application No. 2007-77127 filed on Jul. 31, 2007, in the Korean Intellectual Property Office the entire disclosure of which is hereby incorporated by reference.

### BACKGROUND OF THE INVENTION

1. Field of the Invention

The present invention relates to an apparatus and method capable of using a reconfigurable descriptor in a System on Chip (SoC). More particularly, the present invention relates to an apparatus and method for reading data by using a descriptor that can be reconfigured by a user in an SoC and for performing a hardware function by using the read data according to a predetermined order.

2. Description of the Related Art

A System on Chip (SoC) is a semiconductor device in which several Intellectual Property (IP) blocks are integrated into a single chip. The SoC uses a descriptor to provide a method for accessing and processing various types of data.

One example of a method for using the descriptor in the SoC is a Direct Memory Access (DMA) method. The DMA method performs data transmission between an input/output unit and a memory by using the descriptor without the intervention of a Central Processing Unit (CPU). Instead thereof, the CPU receives a command for controlling data transmission by a hardware element dedicated for DMA control and generates a descriptor by using said hardware element for performing predefined functions.

In the conventional SoC system, the descriptor has a fixed structure as shown in FIG. 1 and performs a predefined function. For example, in the SoC system, as shown in FIG. 2, several units of a descriptor 201 are consecutively formed for transferring data without the intervention of a CPU 203. The descriptor 201 includes a start address 101 (see FIG. 1) of a data chunk recorded in a memory and a data length 103 (see FIG. 1) of the data chunk.

As such, the conventional descriptor has a fixed format. Therefore, in order to process various types of data by using the descriptor, the CPU has to modify the various types of data to fit a format suitable for the descriptor. In addition, when a format of the descriptor needs to be modified, a hardware structure has to be modified as well.

Accordingly, there is a need for an improved apparatus and method capable of using a reconfigurable descriptor in a System on Chip (SoC).

### SUMMARY OF THE INVENTION

Exemplary embodiments of the present invention address at least the above problems and/or disadvantages and provide at least the advantages described below. Accordingly, an aspect of exemplary embodiments of the present invention is to provide an apparatus and method capable of using a reconfigurable descriptor in a System on Chip (SoC).

It is another object of the present invention to provide an apparatus and method for improving hardware flexibility by using a descriptor that can be reconfigured by a user in an SoC.

According to one aspect of an exemplary embodiment of the present invention, there is provided an apparatus and method for reading data by using a descriptor that can be reconfigured by a user in an SoC and for performing functions according to an order predetermined by a user.

According to another aspect of an exemplary embodiment of the present invention, an apparatus capable of using a reconfigurable descriptor in an SoC is provided. The apparatus includes: a Central Processing Unit (CPU) for receiving parameters, each of which defines a descriptor, from a user and for providing the parameters to a controller; and the controller for defining the descriptor by reading target data indicated by the received parameters.

According to a further aspect of an exemplary embodiment of the present invention, a method capable of using a reconfigurable descriptor in an SoC is provided. The method includes the steps of: receiving parameters, each of which defines a descriptor, from a CPU; and defining the descriptor by reading target data indicated by the received parameters.

Other objects, advantages, and salient features of the present invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description when taken in conjunction with the accompanying drawings, in which:

FIG. 1 illustrates a format of a conventional descriptor;

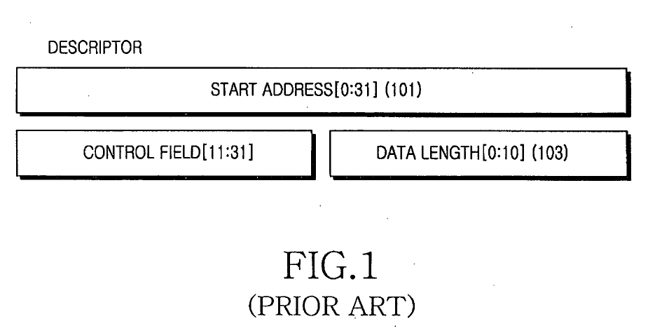

FIG. 2 illustrates an example of using a conventional descriptor in a System on Chip (SoC);

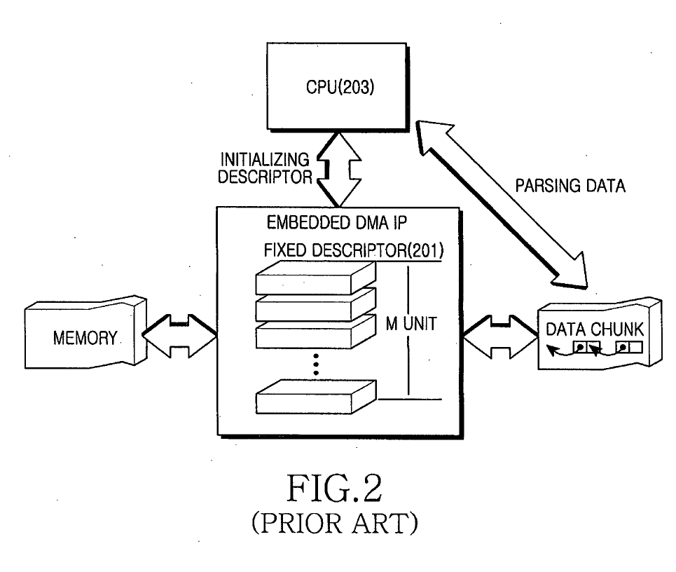

FIG. 3 is a block diagram of an SoC according to an exemplary embodiment of the present invention;

FIGS. 4A, 4B and 4C illustrate a format of a reconfigurable descriptor in an SoC according to an exemplary embodiment of the present invention;

FIGS. 5A and 5B illustrate examples of scheduling functions in an SoC according to an exemplary embodiment of the present invention; and

FIG. 6 is a flowchart illustrating a process of processing data by using a reconfigurable descriptor in an SoC according to an exemplary embodiment of the present invention.

Throughout the drawings, the same drawing reference numerals will be understood to refer to the same elements, features, and structures.

### DETAILED DESCRIPTION OF THE EXEMPLARY EMBODIMENTS

The matters exemplified in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An apparatus and method of the present invention will be described hereinafter which reads data by using a descriptor that can be reconfigured by a user in a System on Chip (SoC) and which performs a hardware function according to a predetermined order by using the read data.

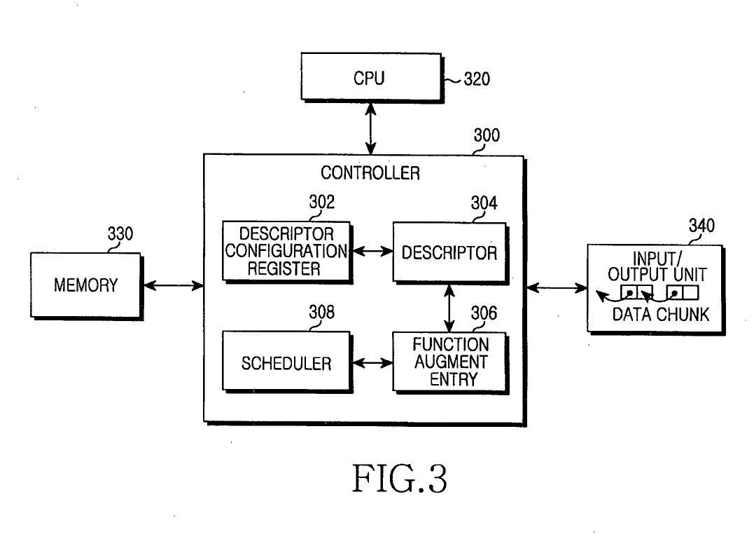

FIG. 3 is a block diagram of an SoC according to an exemplary embodiment of the present invention. The SoC includes a controller 300, a Central Processing Unit (CPU) 320, a memory 330, and an input/output unit 340. The controller 300 includes a descriptor configuration register 302, a descriptor 304, a function augment entry 306, and a scheduler 308.

Referring to FIG. 3, when data has to be transmitted between the memory 330 and the input/output unit 340, the CPU 320 instructs the controller 300 to perform a data transmission function. In particular, according to the present invention, the CPU 320 receives a data set, that is, a start offset of target data and a length of the target data that defines a descriptor input by a user and then provides the data set to the controller 300. In addition to the data transmission function, the CPU 320 provides the controller 300 with specific functions input from the user. In this case, the CPU 320 may receive or determine an order of performing the specific functions.

The controller 300 is a hardware element dedicated to control operations that use a descriptor. The controller 300 performs a function for transmitting data recorded in the controller 300 to the input/output unit 340 without the intervention of the CPU 320 or a function for recording data input from the input/output unit 340 to the memory 330. In particular, according to an exemplary embodiment of the present invention, the controller 300 processes operations for performing the aforementioned functions by using a descriptor that can be reconfigured by the user. For example, the controller 300 may initialize a descriptor, read target data, set a descriptor, and perform a schedule according to an order of performing functions.

That is, by using the descriptor configuration register 302, data that defines the descriptor 304 is input to the controller 300 by the user or the CPU 320, and then the function augment entry 306 is configured under the control of the controller 300 by mapping entries of specific functions instructed by the user or the CPU 320 with parameters of the descriptor 304. The controller 300 reads target data from the memory 330 or the input/output unit 340 by referring to the descriptor configuration register 302, sets the read target data to the descriptor 304, and performs functions corresponding to respective descriptors by referring to the descriptor 304 and the function augment entry 306. In this case, the controller 300 controls the scheduler 308 and thus schedules the respective functions according to a predetermined order.

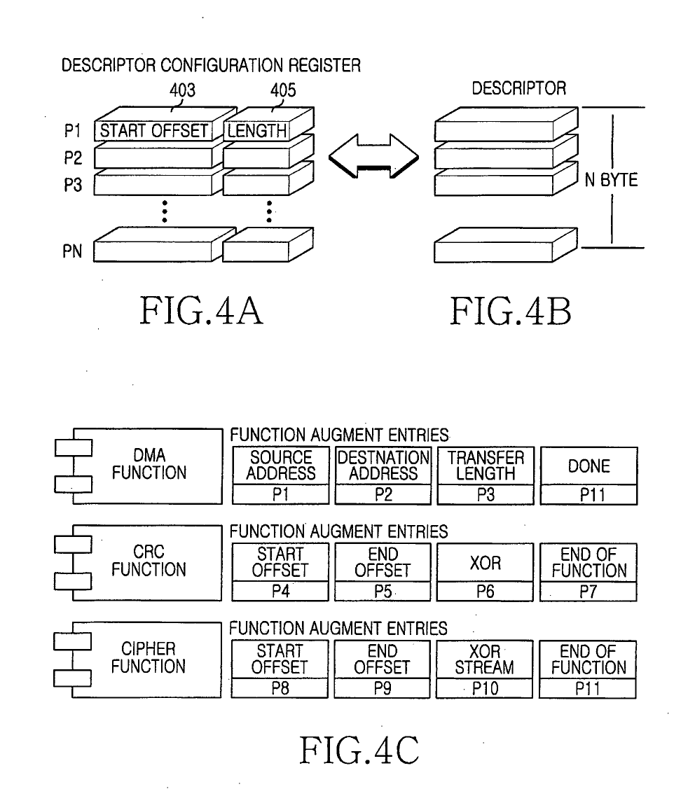

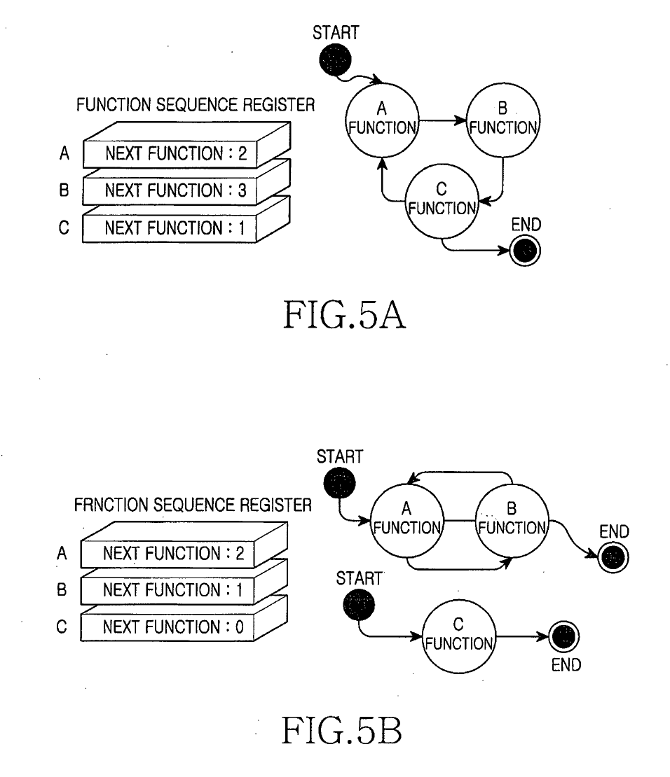

With reference to FIGS. 4A, 4B and 4C, and also FIGS. 5A and 5B, structure of the controller 300 will now be described in detail.

As shown in FIG. 4A, the descriptor configuration register 302 has a format which includes a start offset 403 of target data and a length 405 of the target data. CPU 320 sends the start offset and the length of the target data to the descriptor configuration register 302 to be set to the descriptor, so that parameters P1 to Pn can represent their own target data.

The input/output unit 340 has a format as shown in FIG. 4B. Under the control of the controller 300, the descriptor 304 stores data indicated by each parameter of the descriptor configuration register 302.

As shown in FIG. 4C, under the control of the controller 300, the function augment entry 306 maps entries of specific functions instructed by the CPU 320 with the respective parameters, and then stores the mapping result. Furthermore, the function augment entry 306 maps entries corresponding to functions (for example, DMA function, Cyclic Redundancy Checking (CRC) function, and cipher function) instructed by the user or the CPU 320 so that a specific function can be performed by using target data of each parameter.

The scheduler 308 performs scheduling in such a manner that the respective functions are performed according to an order predetermined by the user or the CPU 320. For example, as shown in FIG. 5A, in a state that an instruction for performing functions A, B, and C is received from the user or the CPU 320, if a function sequence is set such that the function B is a next function of the function A, the function C is a next function of the function B, and the A is a next function of the function C, then the scheduler 308 performs scheduling in such a manner that the functions A, B, and C are sequentially repeated. In addition, as shown in FIG. 5B, if a function sequence is set such that the function B is a next function of the function A, the function A is a next function of the function B, and a next function of the function C does not exist, then the scheduler 308 performs scheduling in such a manner that the function A and the function B are repeated and the function C is performed only once.

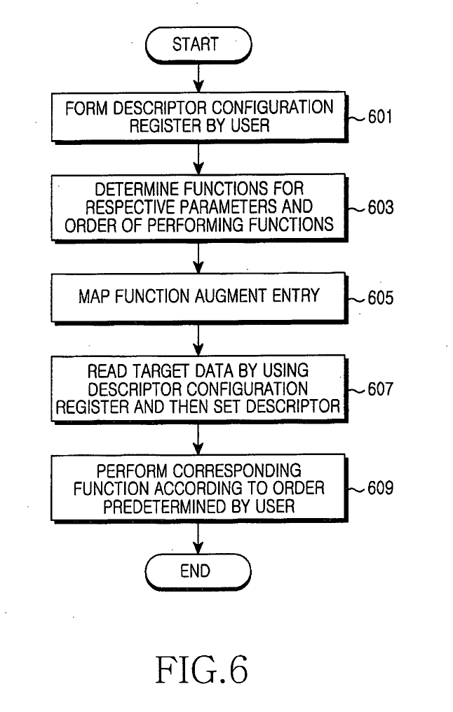

FIG. 6 is a flowchart illustrating a process of processing data by using a reconfigurable descriptor in an SoC according to an exemplary embodiment of the present invention.

Referring to FIG. 6, in step 601, parameters, each of which defines a descriptor, are received from a user, and the received parameters are input to a descriptor configuration register having a format as shown in FIG. 4A. Herein, the parameters are a start offset of target data to be indicated by the user and a length of the target data. For example, the SoC receives from the user or a CPU the start offset and the length of the data to be set to the descriptor. In step 603, entries for the respective parameters, functions, and an order of performing the functions are determined by the user or the CPU.

In step 605, a function augment entry as shown in FIG. 4C is configured by mapping the respective parameters input to the descriptor configuration register with corresponding entries.

In step 607, target data indicated by a corresponding parameter is read by using the start offset and the length of the respective parameters input to the descriptor configuration register. Afterwards, the read data is set to a descriptor as shown in FIG. 4B and is then stored.

In the final step 609 of the procedure shown in FIG. 6, a function to be performed by using the data, which is set to the descriptor, is checked from the function augment entry, and a corresponding function is performed. If several functions have to be performed in step 609, the functions are performed according to an order predetermined by the user or the CPU. Performance of the functions is carried out by using content described in the descriptor and the function augment entry.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

In an exemplary embodiment of the present invention, data is read by using a descriptor that can be reconfigured by a user in a SoC, and the read data is processed according to an order predetermined by the user. Therefore, when a data structure is modified, the descriptor can be reused by modifying only a software algorithm without having to undergo hardware changes. This method improves hardware flexibility and fast data processing can be achieved by minimizing intervention of a CPU.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. An apparatus capable of using a reconfigurable descriptor in a System on Chip (SoC), the apparatus comprising:
a Central Processing Unit (CPU) for receiving parameters from a user; and
a controller for defining a descriptor by reading target data indicated by the received parameters,
wherein each of said parameters defines the descriptor and is provided to the controller.

2. The apparatus of claim 1, wherein the parameters include at least a start offset of data and/or a length of the data to be indicated.

3. The apparatus of claim 1, wherein the controller comprises:
a descriptor configuration register for receiving the parameters from the CPU and for storing the target data read by the controller, wherein each of said parameters defines the descriptor

4. The apparatus of claim 3, wherein the controller further comprises a function augment entry for mapping entries of functions to be performed at the request of the CPU with the respective parameters and for storing the mapping result, and wherein, the controller performs a function corresponding to data stored in the descriptor by referring to the function augment entry.

5. The apparatus of claim 4, wherein the controller further comprises a scheduler for performing scheduling in such a manner that the respective functions are performed according to an order predetermined by the CPU or the user.

6. A method capable of using a reconfigurable descriptor in a System on Chip (SoC), the method comprising the steps of:
receiving parameters from a user at a Central Processing Unit (CPU); and
defining a descriptor, by a controller, by reading target data indicated by the received parameters, wherein each of said parameters defines the descriptor.

7. The method of claim 6, wherein the parameters include at least a start offset of data and/or a length of the data to be indicated.

8. The method of claim 6, wherein the defining of the descriptor comprises:
forming a descriptor configuration register by using the parameters received from a user at the CPU; and
defining a descriptor by reading target data indicated by the respective parameters of the descriptor configuration register.

9. The method of claim 6, further comprising:
generating a function augment entry by mapping entries of functions to be performed at the request of the CPU with the respective parameters received; and
performing a function corresponding to data stored in the descriptor by referring to the function augment entry.

10. The method of claim 9, wherein the performing of a function comprises performing respective functions according to an order predetermined by the CPU or a user.

11. A computer-readable recording medium having recorded thereon a program for using a reconfigurable descriptor in a System on Chip (SoC), comprising:
a first code segment, for receiving parameters from a user at a Central Processing Unit (CPU); and
a second code segment, for defining a descriptor, by a controller, by reading target data indicated by the received parameters, wherein each of said parameters defines the descriptor.
